(19) United States
(12) Patent Application Publication
(10) Pub. No.: US 2017/0270471 A1
(43) Pub. Date: Sep. 21, 2017

(54) SMART BOOKRACK, A SYSTEM, AND A METHOD FOR MANAGING BOOKS USING THE SMART BOOKRACK

(71) Applicants: Fu Tai Hua Industry (Shenzhen) Co., Ltd., Shenzhen (CN); HON HAI PRECISION INDUSTRY CO., LTD., New Taipei (TW)

(72) Inventor: WEN-DONG LUO, Shenzhen (CN)

(21) Appl. No.: 15/459,827

(22) Filed: Mar. 15, 2017

(30) Foreign Application Priority Data
Mar. 17, 2016 (CN) 201610154668.0

(51) Int. Cl. G06Q 10/08; G06K 7/10; A47F 10/02; A47B 63/00; A47F 7/14

(52) U.S. Cl. CPC G06Q 10/087; A47B 63/00; A47F 7/144; A47F 10/02; G06K 7/10297; A47F 2010/005

(57) ABSTRACT

A smart bookrack includes a number of book cabinets. Each book cabinet accommodates one book and carries a sensor and a determining device. Each book includes an electronic tag to identify the book. The smart bookrack further includes a RF unit, a controller, and a display device. The determining device detects whether a book being in each book cabinet. The RF unit scans identification information of each book and transmits the identification information to the controller. The controller determines a status of each book according to actual location of the book and identification information of each book. The display device displays the status of each book by using different signals. A book management system and method using the smart bookrack are also provided.

### CROSS-REFERENCE TO RELATED APPLICATIONS

This application claims priority to Chinese Patent Application No. 201610154668.0 filed on Mar. 17, 2016.

### FIELD

The subject matter herein generally relates to smart bookracks, and particularly to a smart bookrack, a system, and a method for managing books using the smart bookrack.

### BACKGROUND

General public library facilities can be improved by offering a higher level of service.

### BRIEF DESCRIPTION OF THE DRAWINGS

Implementations of the present technology will now be described, by way of example only, with reference to the attached figures.

FIG. 1 is a block diagram illustrating an exemplary embodiment of a book management system.

FIG. 2 is a block diagram illustrating an exemplary embodiment of a smart bookrack in the system of FIG. 1.

FIG. 3 is a schematic diagram illustrating the smart bookrack of FIG. 2.

FIG. 4 is block diagram illustrating a Radio Frequency (RF) unit in the smart bookrack of FIG. 2.

FIG. 5 is a block diagram illustrating a display device in the smart bookrack of FIG. 2.

FIG. 6 is a flowchart illustrating an exemplary embodiment of a book management method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “comprising” means “including, but not necessarily limited to”, it specifically indicates open-ended inclusion or membership in a so-described combination, group, series, and the like.

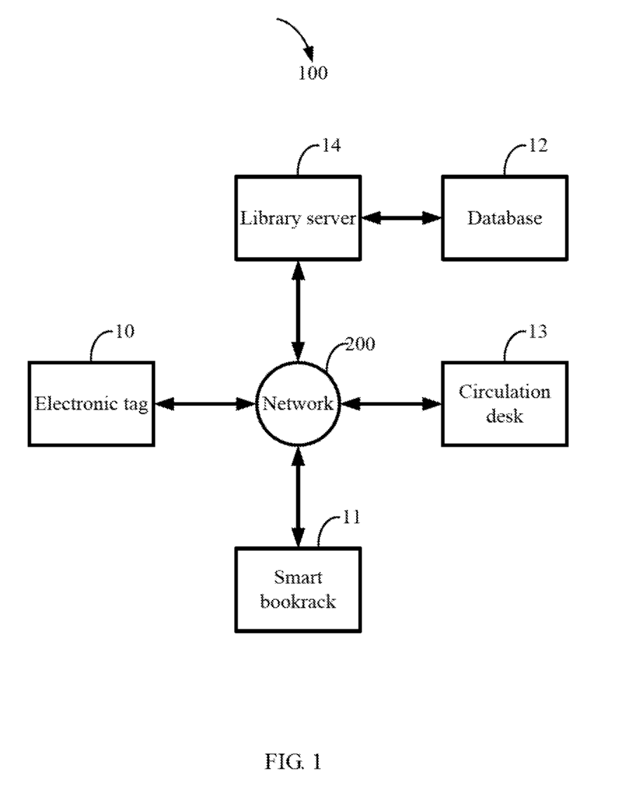

FIG. 1 illustrates an exemplary embodiment of a book management system 100 applied in a library. In the exemplary embodiment, the book management system 100 can include, but is not limited to, a number of electronic tags 10 mounted on books, a number of smart bookracks 11, a database 12, a circulation desk 13, and a library server 14. The tags 10, the smart bookrack 11, the database 12, the circulation desk 13 and the library server 14 communicate with each other through a network 200.

In the exemplary embodiment, each book in the library corresponds to one electronic tag 10. Each electronic tag 10 stores an identification information of the book, the identification information can include, but is not limited to, book title, International Standard Book Number (ISBN), and call number. In the exemplary embodiment, the electronic tag 10 can be pasted on the surface of the book or be pasted inside of the book. In the exemplary embodiment, the electronic tag 10 can be a Radio Frequency (RF) tag.

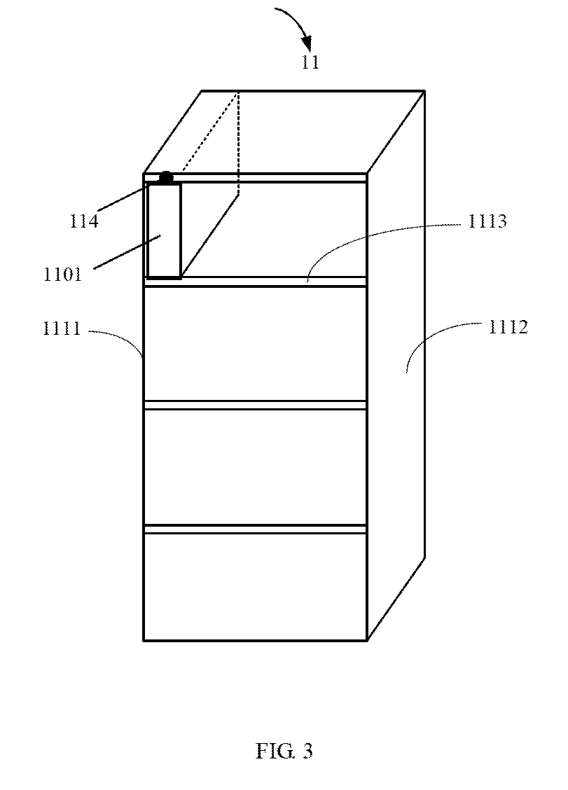

The database 12 stores the identification information of each book of the library. The database 12 further stores a mapping table (not shown) recording a relationship between the location of the books and the identification information of the books. In the exemplary embodiment, the location can indicate which bookrack 11 that the book is normally located and/or which book cabinet 1101 (see FIG. 3) that the book is located. In the exemplary embodiment, each bookrack 11 is associated with a first unique identification, and each book cabinet 1101 is associated with a second unique identification.

The circulation desk 13 can include a Radio Frequency Identification (RFID) reader (not shown). When a book is returned to the circulation desk 13, the RFID reader in the circulation desk 13 scans the electronic tag 10 of the returned book, acquires the identification information of the returned book, and sends the acquired identification information to the library server 14.

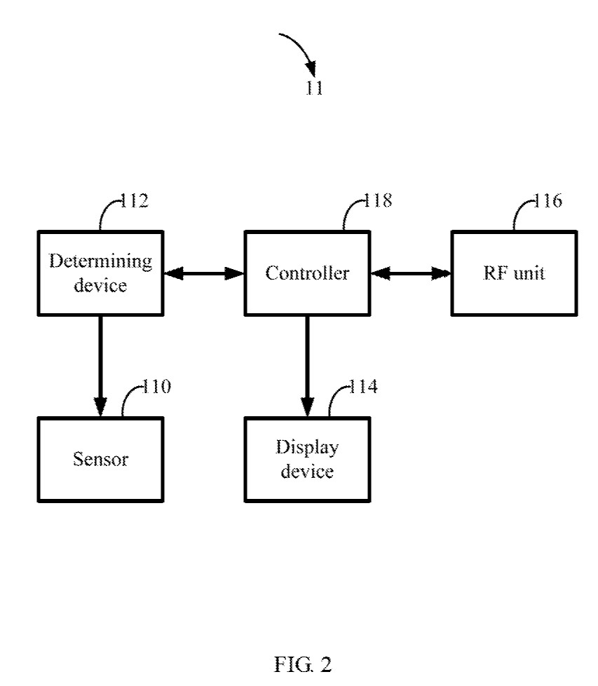

Referring to FIG. 2 and FIG. 3, in the exemplary embodiment, each bookrack 11 can include a left wall 1111, a right wall 1112, a back wall (not shown), and a number of shelves 1113 connected between the left wall 1111 and the right wall 1112. The shelves 1113 are parallel with each other. Each of the shelves 1113 supports a number of book cabinets 1101, each book cabinet 1101 is configured to accommodate one book.

In the exemplary embodiment, as shown in FIG. 2, the bookrack 11 further includes a number of sensors 110, at least one determining device 112, at least one display device 114, at least one RF unit 116, and at least one controller 118. In the exemplary embodiment, one sensor 110 is installed in each book cabinet 1101. The at least one determining device 112 is electronically connected to the sensors 110. The at least one controller 118 communicates with the at least one determining device 112, the at least one display device 114, and the at least one RF unit 116 wirelessly or by wires.

The determining device 112 is configured to detect signals from each sensor 110 to determine whether a book is in the book cabinet 1101. In one exemplary embodiment, the sensor 110 can be a pressure sensor mounted on a bottom surface of the book cabinet 1101. The determining device 112 detects a pressure on the sensor 110 to determine the presence of a book. In detail, when a book is placed on the sensor 110 of the book cabinet 1101, the pressure on the sensor 110 is greater than zero, thus the determining device 112 determines that the book is in the book cabinet 1101. If there is no book in the book cabinet 1101, the pressure on the sensor 110 may be zero. In case of zero pressure, the determining device 112 determines that there is no book in the book cabinet 1101. In one exemplary embodiment, the sensor 110 has a unique identification that is the same as the corresponding book cabinet 1101. In other exemplary embodiments, the second unique identification of the book cabinet 1101 can be mounted on the sensor 110 mounted on the book cabinet 1101.

When it is determined that a book is in the book cabinet 1101, the determining device 112 sends a trigger signal to the controller 118, and the controller 118 sends a control signal to the RF unit 116.

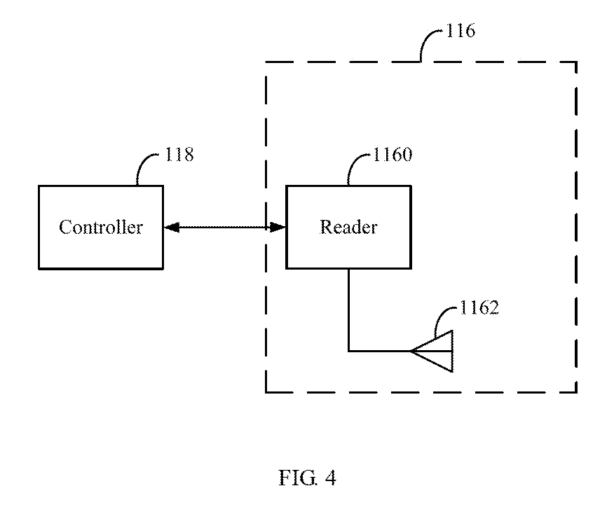

The RF unit 116 is mounted on each bookrack 11 to search out books on the bookrack 11. Referring to FIG. 4, in the exemplary embodiment, the RF unit 116 can include a reader 1160 and a RF antenna 1162. The reader 1160 is configured to scan the electronic tag 10 of the book on the sensor 110. The RF antenna 1162 is configured to transmit RF signals between the reader 1160 and the electronic tag 10. In the exemplary embodiment, the RF antenna 1162 is configured as a vertical antenna to increase transmission efficiency. In the exemplary embodiment, the RF antenna 1162 is mounted in the shelves 1113, and the reader 1160 is mounted in the back wall of the bookrack 11 and is connected with the antenna 1162. In other exemplary embodiments, the reader 1160 and the RF antenna 1162 can be integrated as a whole unit, see FIG. 4.

The at least one display device 114 is controlled by the controller 118 to indicate a status of the books. In the exemplary embodiment, the status of the book can include the book being in a correct book cabinet 1101, the book being in the library but not in any bookrack 11, the book being in an incorrect book cabinet 1101, and the book not being in the library. In the exemplary embodiment, each book cabinet 1101 corresponds to one display device 114.

In a first exemplary embodiment, the display device 114 can be one or more Light Emitting Diodes (LEDs), which can emit different colors of light. The display device 114 indicates the status of the books by emitting different colors of light. For example, the display device 114 can emit green light, red light, and yellow light. If the book is placed in the correct book cabinet 1101, the LED light emits the green light. If the book is in the library but is not in any bookrack 11, the LED light emits the yellow light. If the book has been placed in a wrong book cabinet 1101 (ie. misplaced), the LED light emits the red light and blinks at the same time. If the book is not in the library, the LED light will emit constant red light.

In a second exemplary embodiment, the display device 114 can include three LED lights. A first LED light can emit green light, a second LED light can emit yellow light, and a third LED light can emit red light. The display device 114 indicates the book status by turning on different lights. For example, if the book is placed in the correct book cabinet 1101, the first LED light is turned on to emit green light. If the book is in the library but is not placed in any bookrack 11, the second LED light is turned on to emit yellow light. If the book is placed in a wrong book cabinet 1101, the third LED light is turned on to emit blinking red light. If the book is not in the library, the third LED light is turned on to emit constant red light.

In a third exemplary embodiment, the display device 114 can be an LED light, which can emit different frequencies of light. For example, if the book is not in the library, the LED light is unlit. If the book is in the correct book cabinet 1101, the LED light emits light in a first frequency, and if the book is in a wrong book cabinet 1101, the LED light emits light in a second frequency. If the book is in the library but has not been placed in any bookrack 11, the LED light emits light in a third frequency.

In a fourth exemplary embodiments, the display device 114 further can be a display, which is used to display the status of the books textually or symbolically.

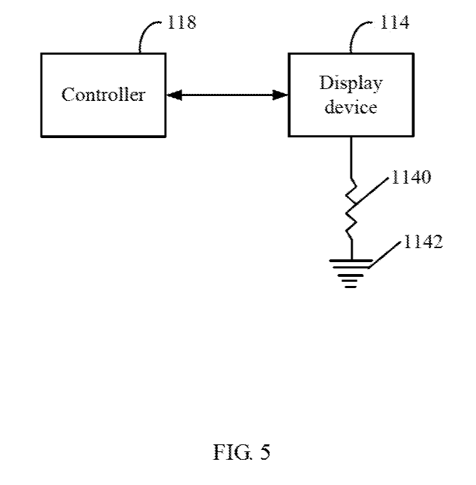

In some exemplary embodiments, the display device 114 further can be connected to ground 1142 through a resistance device 1140 (see FIG. 5). The resistance device 1140 can be a current-limiting resistance, which is used to prevent the display device 114 from burning out.

The controller 118 communicates with the library server 14 through the network 200 wirelessly or by wires. The controller 118 controls the display device 114 to emit different signals to indicate different statuses of each of the books, and transmits the signals emitted by the display device 114 to the library server 14.

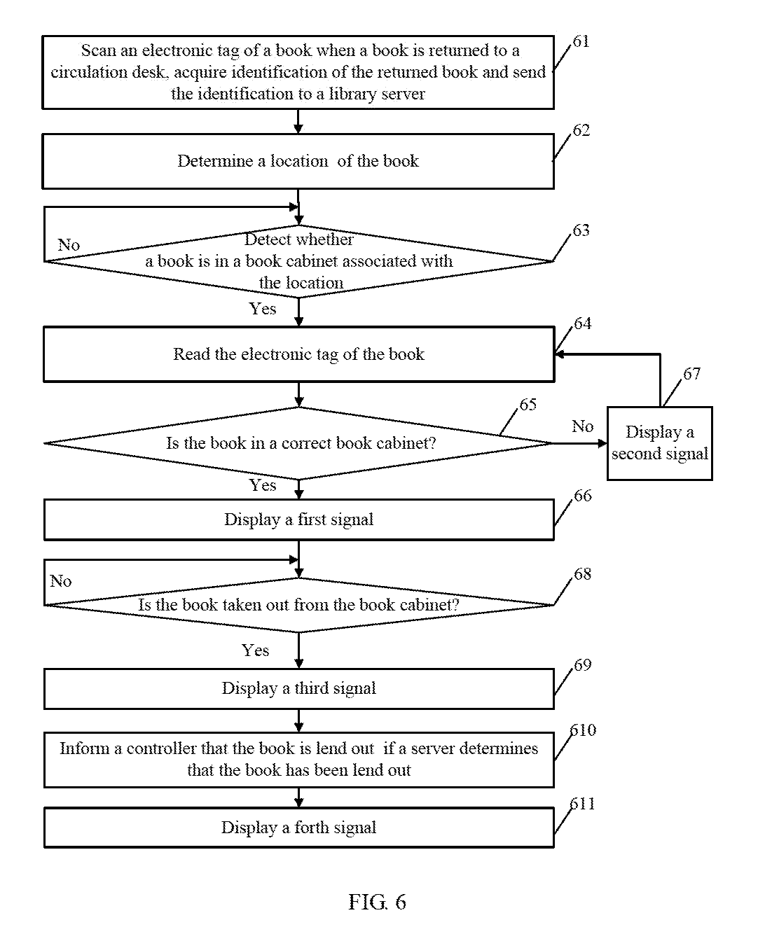

A method for the book management system 100 managing books is indicated in FIG. 6. The method is provided by way of example, as there are a variety of ways to carry out the method. Each block shown in FIG. 6 represents one or more processes, methods, or subroutines carried out in the example method. Additionally, the illustrated order of blocks is by example only and the order of the blocks can be changed. The example method can begin at block 61.

At block 61, when a book is returned to the circulation desk 13, the RFID reader in the circulation desk 13 scans the electronic tag 10 of the returned book, acquires the identification information of the returned book, and sends the acquired identification information to the library server 14.

At block 62, the library server 14 determines the location of the book by searching in the database 12 according to the acquired identification information of the returned book. The library server 14 then transmits the location of the book to the controller 118 and further transmits a control signal to the controller 118 of the at least one bookrack 11.

In the exemplary embodiment, the location of the book can include the first unique identification of the bookrack 11 that the book should be located and/or the second unique identification of the book cabinet 1101 that the book should be located.

At block 63, upon receiving the control signal, the controller 118 controls the determining device 112 to detect whether a book is in the book cabinet 1101 associated with the location determined by the library server 14. If there is a book in the book cabinet 1101, the procedure goes to block 64; otherwise, the procedure repeats block 63.

At block 64, the controller 118 controls the RF unit 116 to read the electronic tag 10 of the book in the book cabinet 1101.

At block 65, the controller 118 determines whether the book is in a correct book cabinet 1101. The controller 118 determines whether the location of the book received from the server matches the identification information of the book read by the reader 1160 according to the mapping table stored in the database 12. If the location matches the identification information of the book read by the reader 1160, the controller 118 determines that the book is in the correct book cabinet 1101, and the procedure goes to block 66. Otherwise, the controller 118 determines that the book is placed in the incorrect book cabinet 1101, and the procedure goes to block 67.

At block 66, the controller 118 controls the display device 114 to display a first signal and feeds the first signal back to the library server 14.

At block 67, the controller 118 controls the display device 114 to display a second signal and feeds the second signal back to the library server 14.

In the first exemplary embodiment, the display device 114 is one or more LED light, which can emit green light, red light, and yellow light. The first signal is green light, and the second signal is blinking red light.

In the second exemplary embodiment, the display device 114 includes three LED lights, the first LED light can emit green light, the second LED light can emit yellow light, and the third LED light can emit red light. The first signal is that the first LED light emits green light, and the second signal is that the third LED light emits blinking red light.

In the third exemplary embodiment, the display device 114 can be the LED light, which can emit different frequencies of light. The first signal is that the LED light emits light in the first frequency, and the second signal is that the LED light emits light in the second frequency.

In the fourth exemplary embodiment, the display device 114 is a display, which is used to display the state of the books by using words or symbols. The first signal can be a sentence that “the book is placed in a right place” or a first symbol “√”, and the second signal is a sentence “the book is placed in a wrong place” or a second symbol “×”.

At block 68, the sensor 110 continuously detect whether the book is taken out from the book cabinet 1101. If the book is taken out, the procedure goes to block 69; otherwise, the procedure repeats block 68.

At block 69, the controller 118 controls the display device 114 to display a third signal, and feeds the third signal back to the library server 14.

At block 610, if the server 14 determines that the book has been lend out, the server 14 informs the controller 118 that the book is lend out.

At block 611, the controller 118 controls the display device to display a fourth signal.

In the first exemplary embodiment, the third signal is that the LED light emits yellow light, and the fourth signal is that the LED light emits constant red light.

In the second exemplary embodiment, the third signal is that the second LED light emits yellow light, and the fourth signal is that the third LED light emits constant red light.

In the third exemplary embodiment, the third signal is that the LED light emits light in a third frequency, and the fourth signal is that the LED light does not emit light.

In the fourth exemplary embodiment, the third signal is that the display device displays a sentence that “the book is taken out” or a third symbol “=”, and the fourth signal is that the display device displays that “the book is lend out” or a fourth symbol “!”. The display device further can display lending information, such as a borrow date and a return data.

It is believed that the present exemplary embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A smart bookrack applied in a library, comprising:
a left wall;
a right wall;
a plurality of shelves connected between the left wall and the right wall, each of the shelves for supporting a plurality of book cabinets, wherein each of the book cabinets is for accommodating a book, each of the books comprises an electronic tag to store an identification information of the book;
a plurality of sensors, each of the book cabinets mounting one of the sensors;
a controller to be connected with a library server to receive a location of each book;
a determining device connected with the sensors to detect signals from each sensor to determine whether a book being in the book cabinet;
a RF unit connected with the controller to scan identification information of each book in each book cabinet, and transmit the identification information to the controller;
the controller further configured to determine a status of each book according to the location of each book and identification information of each book; and
a display device connected to the controller to display the status of each book by using different signals.

2. The smart bookrack of claim 1, wherein the bookrack is associated with a first unique identification, each book cabinet is associated with a second unique identification, the location of each book comprises the first unique identification of the bookrack where the book should be located and the second unique identification of the book cabinet where the book should be located.

3. The smart bookrack of claim 1, wherein the sensor is a pressure sensor mounted on a bottom surface of the book cabinet, the determining device detects a pressure on the sensor to determine whether a book is in the book cabinet; wherein when the pressure on the sensor is greater than zero, the determining device determines a book being in the book cabinet, when the pressure on the sensor is zero, the determining device determines no book being in the book cabinet.

4. The smart bookrack of claim 1, wherein the status of the each book comprises the book being in a correct book cabinet, the book being in the library but not in any bookrack, the book being in an incorrect book cabinet, and the book not being in the library; wherein the display device displays a first signal to indicate the book being in the correct book cabinet, displays a second signal to indicate that the book being in the library but not in any bookrack, displays a third signal to indicate that the book being in an incorrect book cabinet, and displays a fourth signal to indicate that the book not being in the library.

5. A book managing system applied in a library comprising a plurality of books, the book managing system comprising:
a plurality of electronic tags, each of the books comprising one of the electronic tags, each of the electronic tags being configured to store identification information of the corresponding book;
a database to store a mapping table, the mapping table recording a relationship between a location of each book and the identification information of each book;
a library server; and
a plurality of smart bookracks to place the plurality of books, each smart bookrack comprising:
a plurality of book cabinets, each book cabinet accommodating a book;
a plurality of sensors mounted on each of the book cabinets;
a controller to be connected with the library server to receive a location of each book from the library server;
a determining device connected with the sensors to detect signals from each sensor to determine whether a book being in the book cabinet;
a RF unit connected with the controller to scan identification information of each book in each book cabinet, and transmit the identification information to the controller;
the controller further configured to determine a status of each book according to the location of each book and identification information of each book; and
a display device connected to the controller to display the status of each book by using different signals.

6. The book management system of claim 5, wherein the bookrack is associated with a first unique identification, each book cabinet is associated with a second unique identification, the location of each book comprises the first unique identification of the bookrack where the book should be located and the second unique identification of the book cabinet where the book should be located.

7. The book management system of claim 6, wherein, the book managing system further comprises a circulation desk for scanning identification information of each returned book, the library server receives identification information of each returned book from the circulation desk and searches the database to obtain the location of the returned book according to the mapping table, and sends the location of the returned book to the controller.

8. The book management system of claim 5, wherein the sensor is a pressure sensor mounted on a bottom surface of the book cabinet, the determining device detects a pressure on the sensor to determine whether a book is in the book cabinet; wherein when the pressure on the sensor is greater than zero, the determining device determines a book being in the book cabinet, when the pressure on the sensor is zero, the determining device determines no book being in the book cabinet.

9. The book management system of claim 5, wherein the status of the each book comprises the book being in a correct book cabinet, the book being in the library but not in any bookrack, the book being in an incorrect book cabinet, and the book not being in the library; wherein the display device displays a first signal to indicate the book being in the correct book cabinet, displays a second signal to indicate that the book being in the library but not in any bookrack, displays a third signal to indicate that the book being in an incorrect book cabinet, and displays a fourth signal to indicate that the book not being in the library.

10. A book management method by using at least one smart bookrack, the book management method being applied in a library, the library comprising a database, a library server, a plurality of bookracks, and a plurality of electronic tags mounted on books to store identification information of corresponding book, the bookrack comprising a plurality of book cabinets, each book cabinet comprising one sensor, the method comprising:
receiving a location of each book from the library server by a controller of the bookrack;
continuously detecting a signal from each sensor of each bookrack;
scanning identification information of each book and transmitting the identification information to the controller by a RF unit of the bookrack;
determining a status of each book according to the location of each book and the identification information of each book by the controller; and
displaying a signal to indicate the status of each book.

11. The book management method of claim 10, wherein the bookrack is associated with a first unique identification, each book cabinet is associated with a second unique identification, the location of each book comprises the first unique identification of the bookrack where the book should be located and the second unique identification of the book cabinet where the book should be located.

12. The book management method of claim 10, further comprising:
scanning identification information of a returned book and sending the identification information of the returned book to the server by a RFID reader; and
searching in the database to obtain the location of the returned book and sending the location of the returned book to the controller.

13. The book management method of claim 10, further comprising:
detecting a pressure on the sensor to determine whether a book being placed in corresponding book cabinet;
determining that a book being in the book cabinet and scanning the identification information of the book if the pressure on the sensor is greater than zero; and
continuing to detecting the signal from the sensor if the pressure on the sensor is zero.

14. The book management method of claim 10, wherein the status of the each book comprises the book being in a correct book cabinet, the book being in the library but not in any bookrack, the book being in an incorrect book cabinet, and the book not being in the library; wherein the method further comprises: displaying a first signal to indicate the book being in the correct book cabinet, displaying a second signal to indicate that the book being in the library but not in any bookrack, displaying a third signal to indicate that the book being in an incorrect book cabinet, and displaying a fourth signal to indicate that the book not being in the library.
